(19) United States
(12) Patent Application Publication
(10) Pub. No.: US 2003/0000309 A1
(43) Pub. Date: Jan. 2, 2003

(54) Torque measurement

(76) Inventors: Anthony Lonsdale, Banbury (GB); Bryan Lonsdale, Banbury (GB)

Correspondence Address: KEUSEY, TUTUNJIAN & BITETTO, P.C., 14 VANDERVENTER AVENUE, SUITE 128, PORT WASHINGTON, NY, 11050, US

(21) Appl. No.: 09/896,543

(22) Filed: Jun. 29, 2001

(51) Int. Cl. G01D 9/00

(52) U.S. Cl. 73/650

(57) ABSTRACT

A method and apparatus for measuring the torque transmitted by a member comprises a SAW device (66) secured to the member such that mechanical stress in the member due to torque transmitted thereby induces bending of the SAW device. Means are provided for measuring the change in resonant frequency of the SAW device induced by bending. In one embodiment, a hole (52) is formed in the member (50) and the SAW device is mounted in a pair of diametrically opposite slots provided in the hole (52). The SAW device comprises a substrate on which electrode pairs are laid down, the electrode pairs being in a position such that bending of the SAW device results in compression of the zone containing one electrode pair and tension in a zone comprising another electrode pair. In an alternative arrangement the member is formed with a recessed portion in the surface thereof and the SAW device is mounted in a pair of slots formed by opposite walls of the recess. The axis about which torque is applied preferably lies in or is substantially parallel to the plane of the SAW device.

The present invention relates to a method for measuring torque and, particularly, but not exclusively, to a method for measuring the torque arising in a rotating shaft. Also, the invention relates to a member for transmitting torque incorporating means for measuring torque transmitted by said member.

It is well known for Surface Acoustic Wave (SAW) devices to be used for measuring parameters such as temperature and strain. Such devices are comprised of a SAW resonator made up of a micro-structure deposited on a piezoelectric substrate. The deposit is arranged to form at least one pair of interleaved comb-like electrodes. Typically, the electrodes are made from aluminum (although other good conductors may be used) and have a thickness in the order of 100 Angstroms. The piezoelectric substrate is typically manufactured from ceramic or quartz material. The electrodes are protected by an insulating lid member which covers one side of the substrate. The arrangement is such that the electrodes are completely encapsulated between the substrate and the lid member.

In use, the application of an electric pulse signal to one electrode of an electrode pair causes the associated SAW resonator to act as a transducer. The electric input signal is converted to an acoustic wave which is transmitted via the substrate to the other electrode of the electrode pair. On arrival of the acoustic wave at said other electrode, the transducing process is reversed and an electric output signal is generated. This output signal has a characteristic resonant frequency which is dependent upon a number of factors including the geometry of the micro-structure deposit (e.g. the spacing between the interleaved electrodes). Since the spacing of the interleaved electrodes within an electrode pair varies as the substrate is deformed (e.g. by virtue of temperature variations or the application of a mechanical force), a change in the condition of a SAW resonator can be determined by monitoring the resonant frequency. In this way, parameters such as temperature and strain which affect the condition of a SAW resonator may be measured. For example, if the temperature of a SAW resonator is reduced, then the piezoelectric substrate reduces in size and the interleaved electrodes move closer together. As a result. the resonant frequency of the SAW resonator increases. This increase can be measured and calibrated to provide an indication of the temperature change.

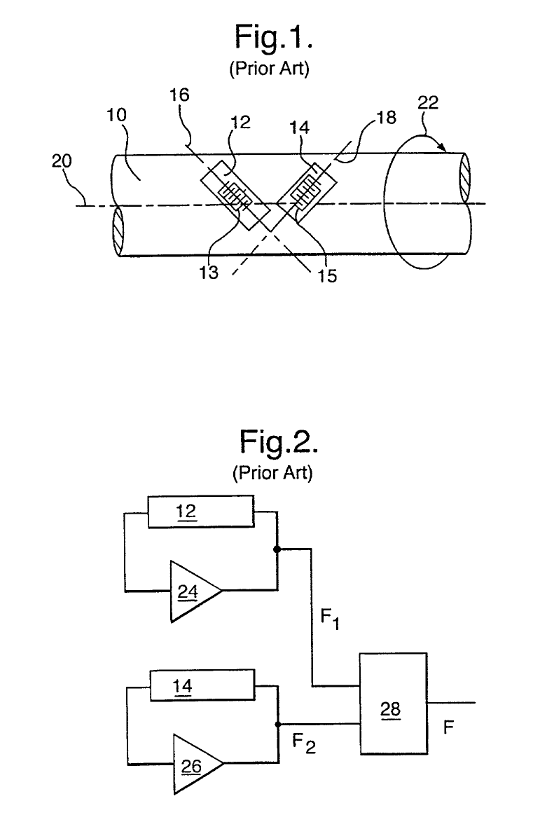

A known method of measuring torque in a shaft or other torque transmitting member through use of one or more SAW resonators is described in EP 0 518 900 B1. A preferred arrangement disclosed in this prior art is shown schematically in FIGS. 1 and 2 of the accompanying drawings. A shaft 10 is provided with two SAW resonators 12,14 for sensing compressive and tensile strain. Each SAW resonator 12,14 incorporates a pair of electrodes 13,15. The two SAW resonators 12.14 are mounted on the shaft 10 with their centre lines 16,18 located at right angles to one another and at 45° to the shaft longitudinal axis 20. The resonator substrates are each securely attached to the surface of the shaft 10 by means of an adhesive. Thus, stress generated in the shaft 10 due to a transmission of torque thereby results in a strain being induced in each SAW resonator 12,14. Torque applied to the shaft 10 in the clockwise direction shown by arrow 22 induces compressive strain in the first SAW resonator 12 and tensile strain in the second SAW resonator 14. If the torque direction is reversed, then the first SAW resonator 12 is placed in tension and the second SAW resonator is placed in compression.

The first and second SAW resonators 12,14 are respectively coupled with first and second amplifiers 24,26 (see FIG. 2) which respectively provide input signal frequencies F₁ and F₂ to a mixer 28. The mixer 28 generates an output signal frequency F having F₁+F₂ and F₁−F₂ components. The torque transmitted by the shaft 10 is measured by reference to the change in input signal frequencies F₁, F₂ generated by the SAW resonators 12,14. This change in frequencies arises from a change in shape of the resonator substrates as a consequence of a deformation of the shaft surface upon which the resonators are secured. Changes in substrate geometry due to temperature, for example, apply to both of the SAW resonators 12,14 equally. Thus, the F₁−F₂ component of the mixer output frequency F provides an indication of only the torque transmitted by the shaft 10. Accordingly, irrespective of temperature, when the torque transmitted by the shaft 10 is zero for example, the F₁−F₂ component will be zero (or close to zero). The F₁+F₂ component of the mixer output signal frequency F provides an indication of the temperature of the material to which the substrate of each SAW resonator is secured. In this way, compensation may be made for variations in deformation characteristics with ambient temperature.

A further prior art arrangement is disclosed in JP 59060332 A. In this further arrangement, first and second SAW resonators are mounted by means of adhesive on a flexible beam extending between two rings longitudinally spaced on a torque transmitting shaft. The SAW resonators are longitudinally spaced on the flexible beam so as to sense compressive and tensile strain, and thereby allow for temperature variations. In use, torque transmitted by the shaft produces a circumferential offsetting of the two rings which, in turn, causes a deformation of the flexible beam. The resultant strains induced in the SAW resonators generate a variation in resonant frequencies. This allows the torque transmitted by the shaft to be determined.

Although the arrangements disclosed in the aforementioned prior art are effective at measuring torque, a number of problems are nevertheless associated therewith. Firstly, it is desirable in the prior art arrangements for two separate SAW resonators (having discrete substrates) to be provided in order to compensate for temperature variations. These separate resonators must be each individually secured in a required orientation relative to both each other and the member upon which they are mounted. This can be time consuming and tends to undesirably increase manufacturing costs. Furthermore, the reliance on two separate resonators for temperature compensation can lead to reliability problems. In the prior art arrangements, if a substrate becomes cracked, then an erroneous signal will tend to be generated by the damaged SAW resonator. Typically, the damaged SAW resonator will fail to generate any signal. If this occurs, then the F₁−F₂ component will give rise to an incorrect torque measurement. The failure of a SAW resonator may not be evident from the incorrect measurement and an operator or associated system will be generally unaware of the measurement error.

A further problem associated with the prior art arrangements arises from the need for an adhesive to both retain the SAW resonators in the required orientation and reliably transmit strain between the resonator substrates and the surface upon which the resonators are mounted. In the prior art, the SAW resonators are arranged so as to stretch or contract in a plane along their centre lines. The stretching and contracting forces are applied to the resonators via the adhesive. If the sheer characteristics of the adhesive are poor, then the performance of the prior art arrangements in determining torque will be adversely affected. This is particularly the case where torque is applied to a shaft for prolonged periods of time. In these circumstances, adhesives tend to fail and the resonators either become detached from the shaft or relax back to an unstrained condition. Furthermore, the use of adhesive can undesirably limit the temperature range in which torque can be reliably measured.

It is an object of the present invention to provide a method of measuring torque in a convenient, reliable and relatively inexpensive manner.

It is a further object of the present invention to provide a member for transmitting torque which comprises means for measuring said torque in a convenient, reliable and relatively inexpensive manner.

A first aspect of the present invention provides a method of measuring torque transmitted by a member. the method comprising the step of retaining a SAW resonator adjacent said member in such an orientation that, during use of said member, mechanical stress in said member due to a torque transmitted thereby induces mechanical strain in the SAW resonator, said induced strain in the SAW resonator being at least substantially generated by a bending of the SAW resonator.

Thus, a method according to the present invention provides for the retaining of a SAW resonator adjacent a torque transmitting member so that, upon torque transmission, the strain induced in the SAW resonator is at least substantially generated by the SAW resonator undergoing a bending action. This is in contrast to the prior art arrangements in which SAW resonators are subjected to strain by virtue of a stretching or contraction within the plane of their substrate. Since the method of the present invention provides for the bending of a SAW resonator during torque transmission, certain substrate portions of the resonator will be subjected to compressive strain whilst other substrate portions will be subjected to tensile strain. This is a well known characteristic of a bending beam. Accordingly, a first electrode pair may be arranged on a first substrate portion which is subjected to compressive strain during bending of the SAW resonator, whilst a second electrode pair may be arranged on a second substrate portion which is subjected to tensile strain during bending. For example, the first and second electrode pairs may be located on opposite sides of the resonator substrate. In this way, a single SAW resonator having merely one discrete substrate may be used to provide torque measurement with temperature compensation. If the substrate becomes damaged (e.g. cracked), then each electrode pair will tend to be affected.

Preferably, the orientation of the SAW resonator is such that a plane in which electrodes of the resonator are arranged is at an angle to a portion of the surface of said member adjacent the resonator. Ideally, said angle is 90°. It is also preferable for the orientation of the SAW resonator to be such that a longitudinal axis of said member about which said torque is applied lies in or is substantially parallel to a plane in which electrodes of the resonator are arranged.

Furthermore, it is preferable for the step of retaining the SAW resonator adjacent said member to comprise the step of providing said member with means integral to said member for receiving the SAW resonator in said orientation. The step of providing means for receiving the resonator may comprise the step of forming a slot in said member. The step of forming a slot may comprise the steps of drilling a hole in said member and cutting one or more slots into the wall of the hole. The step of forming a slot may comprise the steps of forming a recess in said member which extends about a longitudinal axis of said member and cutting one or more slots into one or more walls of the recess. The slot may be of such a size that the SAW resonator is clamped by the slot.

It is also desirable for the step of retaining the SAW resonator adjacent said member to comprise the step of varying the size of the slot and/or the SAW resonator by varying the temperature thereof so as to assist in locating the resonator within the slot.

A second aspect of the present invention provides a member for transmitting torque comprising a SAW resonator orientated so that, during use of said member, mechanical stress in said member due to a torque transmitted thereby induces mechanical strain the SAW resonator, said induced strain in the SAW resonator being at least substantially generated by a bending of the SAW resonator.

Preferably, the orientation of the SAW resonator is such that a plane in which electrodes of the resonator are arranged is at an angle to a portion of the surface of said member adjacent the resonator. Ideally, said angle is 90°. It is also preferable for the orientation of the SAW resonator to be such that a longitudinal axis of said member about which said torque is applied lies in or is substantially parallel to a plane in which electrodes of the resonator are arranged.

Furthermore, it is preferable for said member to comprise integral means for receiving the SAW resonator in said orientation. The means for receiving the resonator may be a slot in said member. Preferably, the slot is of such a size that the SAW resonator is clamped by the slot.

It is preferable for the SAW resonator to comprise two pairs of electrodes. The two pairs of electrodes are preferably arranged on the same side of a substrate so as to be located at different locations along the longitudinal axis of said member. Alternatively the two pairs of electrodes may be arranged on opposite sides of a substrate. The two pairs of electrodes preferably have different geometries so as to be operable at different frequencies. The SAW resonator may comprise four pairs of electrodes, wherein two pairs of electrodes are arranged on opposite sides of a substrate. The four pairs of electrodes preferably have different geometries so as to be operable at different frequencies.

A third aspect of the present invention provides a method of measuring torque transmitted by a member, the method comprising the step of retaining a SAW resonator adjacent said member with means for receiving and restricting displacement of the SAW resonator. The means for receiving and restricting displacement of the SAW resonator is preferably integral with said member. The means for receiving and restricting displacement of the SAW resonator preferably clamps the SAW resonator. The step of retaining a SAW resonator adjacent said member may comprise the step of forming a slot in said member. The step of forming a slot may comprise the steps of drilling a hole in said member and cutting one or more slots into the wall of the hole. The step of forming a slot may comprise the steps of forming a recess in said member which extends about an longitudinal axis of said member and cutting one or more slots into one or more walls of the recess. It is also desirable for the step of retaining the SAW resonator adjacent said member to comprise the step of varying the size of the slot and/or the SAW resonator by varying the temperature thereof so as to assist in locating the resonator within the slot.

A fourth aspect of the present invention provides a member for transmitting torque comprising a SAW resonator retained adjacent said member by means for receiving and restricting displacement of the SAW resonator. The means for receiving and restricting displacement of the SAW resonator is preferably integral with said member. The means for receiving and restricting displacement of the SAW resonator preferably clamps the SAW resonator. The means for receiving and restricting displacement of the SAW resonator is preferably a slot defined in said member.

Embodiments of the present invention will now be described with reference to the accompanying drawings, in which:

FIG. 1 is a schematic view of a prior art arrangement in which a shaft is provided with first and second SAW resonators;

FIG. 2 is a schematic circuit diagram of the first and second SAW resonators of FIG. 1 in association with a frequency mixer;

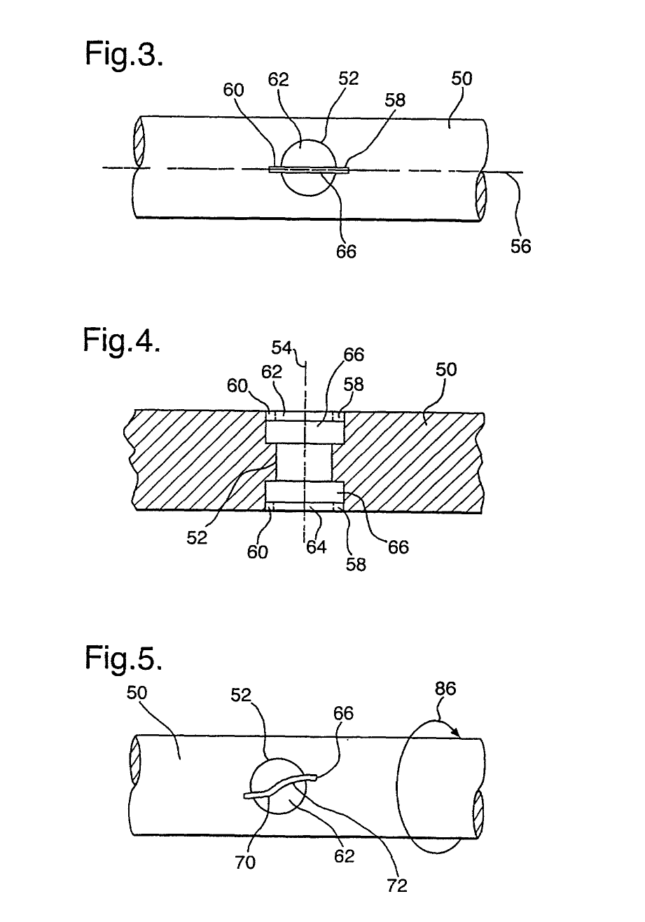

FIG. 3 is a schematic view of a shaft provided with a SAW resonator in accordance with the present invention;

FIG. 4 is a schematic cross-sectional view of the shaft shown in FIG. 3;

FIG. 5 is a schematic view of the shaft shown in FIG. 3 transmitting a torque;

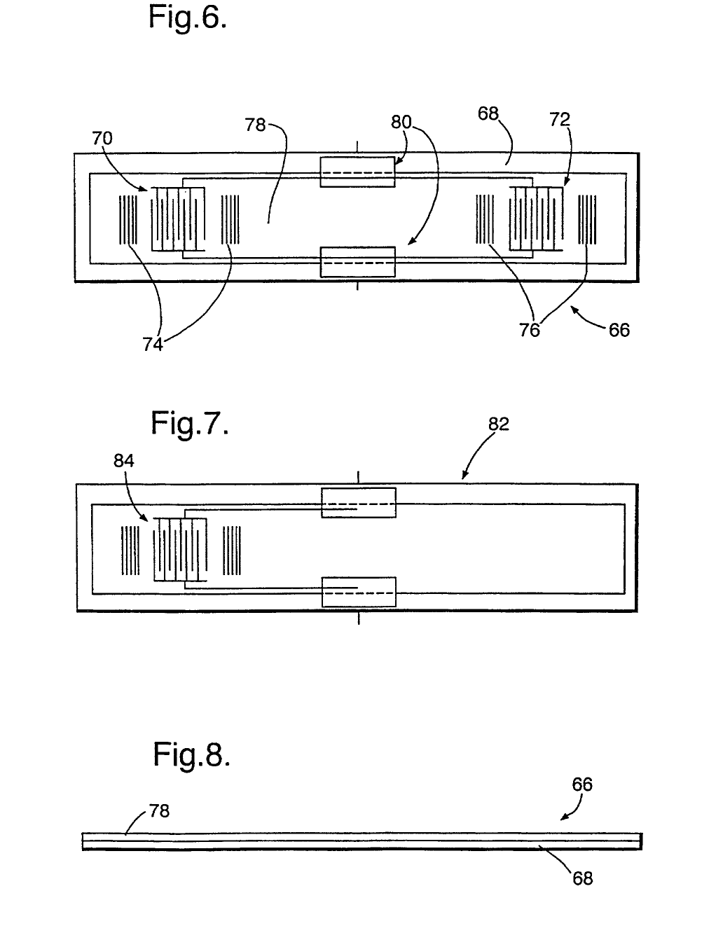

FIG. 6 is a schematic plan view of the SAW resonator shown in FIG. 3;

FIG. 7 is a schematic plan view of an alternative SAW resonator;

FIG. 8 is a schematic side view of the SAW resonator shown in FIG. 6;

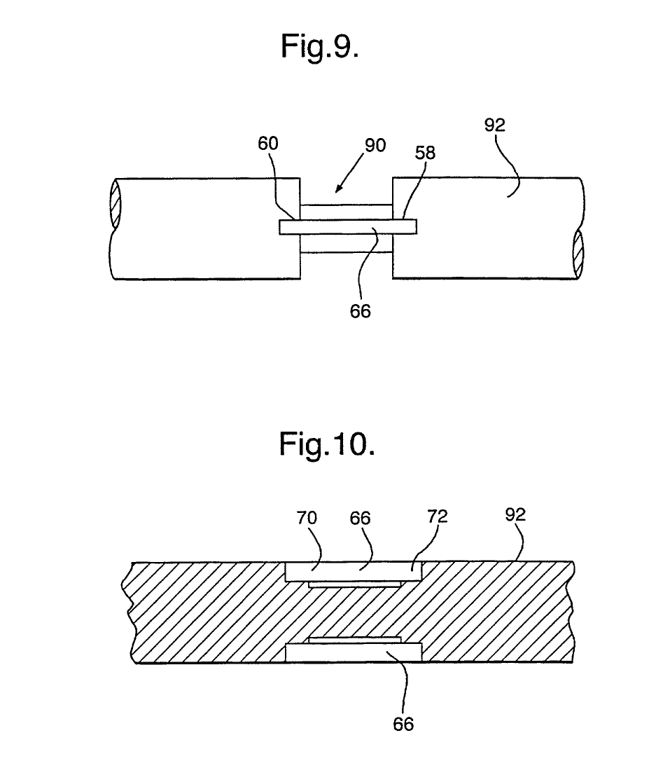

FIG. 9 is a schematic view of a second shaft provided with a SAW resonator in accordance with the present invention;

FIG. 10 is a schematic cross-sectional view of the second shaft shown in FIG. 9;

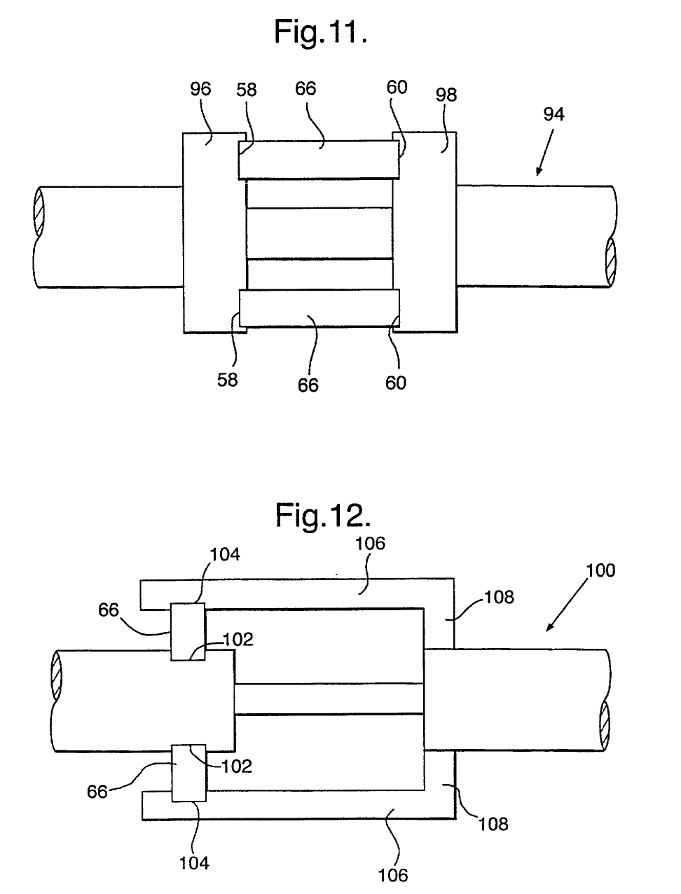

FIG. 11 is a schematic view of a third shaft provided with a SAW resonator in accordance with the present invention; and

FIG. 12 is a schematic view of a fourth shaft provided with a SAW resonator in accordance with the present invention.

As discussed hereinabove, FIGS. 1 and 2 of the accompanying drawings show the prior art arrangement for measuring torque in a shaft described in EP 0 518 900 B1. The prior art arrangement provides first and second SAW resonators 12,14 securely attached by means of adhesive to the surface of a shaft 10. Each SAW resonator 12,14 incorporates a pair of electrodes 13,15. The electrodes of each SAW resonator 12,14 are arranged on the shaft surface so as to have differing orientations. The arrangement is such that, when the shaft 10 transmits a torque and undergoes consequential twisting, the SAW resonators 12,14 either stretch or contract along their centre lines 16,18. In this way, the spacing between the interleaved electrodes of an electrode pair is varied so as to generate a change in resonant frequency. The stretching or contracting of a resonator along its centre line generally occurs in the plane of the substrate without significant bending. Indeed, a significant tendency for the SAW resonators to bend upon torque transmission by the shaft is undesirable since such a tendency would increase the demands on the adhesive and possibly lead to the resonators becoming detached from the shaft surface. However, due to the very small size of the SAW resonators and the small twisting deflection typically experienced by a torque transmitting shaft, either zero or close to zero bending of the SAW resonators occurs.

An arrangement according to the present invention is shown in FIGS. 3 to 5. A shaft 50 adapted to transmit torque is shown in FIG. 3 in an unstrained condition. The shaft 50 is provided with a circular hole 52 which extends from one side of the shaft 50 to an opposite side thereof. The longitudinal axis 54 of the hole 52 intersects with the longitudinal axis 56 of the shaft 50. Said two axes 54,56 are perpendicular to one another. Two slots 58,60 extend radially from the hole axis 54 into opposite wall portions of one end 62 of the hole 52 (see FIG. 4 in particular). Identical slots 58,60 are also located at an opposite end 64 of the hole 52. The slots 58,60 lie on the same plane as the hole and shaft axes 54,56 (when the shaft 50 is an unstrained condition).

Each pair of slots 58,60 is of sufficient depth and width to receive a single SAW resonator 66. The SAW resonator 66 extends from one slot to an opposite slot so as to span the diameter of the hole 52. The width of the slots 58,60 is such that the SAW resonator 66 forms an interference fit therewith. The SAW resonator 56 is therefore clamped in position by the slots 58,60. However, in an alternative embodiment, a SAW resonator may fit loosely within a slot pair and be thereby adequately retained adjacent a shaft. In the present embodiment, the slots 58,60 are sufficiently deep for a SAW resonator 66 to be held below the outer surface of the shaft 50. Furthermore, the hole 52 and slots 58,60 are filled with silicone rubber so as to totally encapsulate and protect each SAW resonator 66.

A schematic plan view of a SAW resonator 66 is shown in FIG. 6 of the accompanying drawings. The SAW resonator 66 comprises an elongate substrate 68 upon which two electrode pairs 70,72 are mounted. The electrode pairs 70,72 are located at opposite end portions and arranged on the same side of the substrate 68. As is known in the art, each electrode pair 70,72 is provided with a pair of reflectors 74,76. A lid member 78 is secured to the substrate 68 so as to cover and thereby protect the electrode pairs 70,72. The lid member 78 also partially covers coupling means 80 common to both electrode pairs 70,72. This coupling means 80 allows for the connection of the SAW resonator 66 to an amplifier and means (not shown) for supplying an excitation signal to the resonator and for receiving a response signal from the resonator. The electrode pairs 70,72 have differing configurations (not apparent from FIG. 6) so as to be operable at different frequencies. This allows for the use of the common coupling means 80. A side view of the SAW resonator 66 is shown in FIG. 8.

An alternative embodiment of the present invention may incorporate a SAW resonator having a different electrode pair arrangement to that of the SAW resonator 66 shown in FIGS. 6 and 8. For example, a SAW resonator 82 may be used having merely a single electrode pair 84 (see FIG. 7). Alternatively, a SAW resonator may be provided having two electrode pairs arranged on opposite sides of a substrate. Furthermore, a SAW resonator may be provided having four electrode pairs, two of which are arranged on one side of a substrate and two of which are arranged on an opposite side of said substrate. In cases where electrode pairs are arranged on both sides of a substrate, both of said substrate sides are provided with a lid member. In all cases, it is preferable for electrode pairs to have differing configurations so as to be operable independently by excitation signals of different frequencies. A common coupling means may then be used.

In use, a twisting of the shaft 50 about the shaft axis 56 will generate a bending of the two SAW resonators 66. The electrode pairs 70,72 are located on the resonator substrate 68 so as to be subjected to maximum levels of compressive/tensile strain upon resonator bending. Thus, when the shaft 50 is subjected to a torque applied in the direction indicated by arrow 86 (see FIG. 5). the SAW resonators 66 are elastically bent into an S shape which places each side of the resonator substrate 68 into both tension and compression. This is a well-known characteristic of a bending beam and will be readily understood by those skilled in the art. As a consequence of the bending action shown in FIG. 5, the portion of substrate 68 adjacent the first electrode pair 70 is placed in tension whilst the portion of substrate 68 adjacent the second electrode pair 72 is placed in compression. The resultant resonant frequencies from the two electrode pairs 70,72 allow for torque measurement with temperature compensation in a manner similar to that discussed in relation to the prior art.

The arrangement shown in FIGS. 3 to 5 is manufactured by forming a hole 52 in an appropriate shaft 50 using conventional drilling techniques. Once formed. the hole 52 allows appropriate cutting tools access for cutting of the slots 58,60. Where the dimensions of the slots 58,60 are such that the associated SAW resonator 66 forms an interference fit therewith, assembly is assisted by heating and thereby expanding the shaft 50 in the region of the hole 52. In this way, the slots 58,60 tend to widen so as to allow unrestricted insertion of a resonator. Once the resonator is located satisfactorily within a pair of slots, the shaft 50 may be allowed to cool. The pair of slots will then tend to contract and clamp the resonator. The hole 52 and exposed portions of the slots 58,60 are then filled with silicone rubber.

The present invention is not limited to the specific embodiment or method descried above. Alternative arrangements and suitable material will be apparent to a reader skilled in the art. For example, the hole 52 may be oval in cross-section rather than circular. Indeed, access for suitable slot cutting tools may be provided by means other than a hole 52. In this regard, FIGS. 9 and 10 of the accompanying drawings show an alternative embodiment of the present invention in which a circumferential recess 90 is formed in the surface of a shaft 92. The recess 90 may be conveniently provided by means of conventional turning techniques. An appropriate number of slots 58,60 may then be cut into the walls of the recess 90 for receiving the required number of SAW resonators 66. In the embodiment shown in FIGS. 9 and 10. two resonators 66 are provided on opposite sides of the shaft 92, however an alternative number of resonators may be used. In addition, although the shaft 92 (and the shaft 50 shown in FIGS. 3 to 5) is provided with two identical SAW resonators 66, it may be desirable in certain applications for the electrode pairs on the two resonator substrates to have differing configurations so as to be independently operable at different signal frequencies.

A further alternative embodiment of the present invention is shown in FIG. 11 of the accompanying drawings. This figure shows a further shaft 94 having two portions 96,98 of enlarged diameter between which two SAW resonators 66 extend. The ends of each SAW resonator 66 are located in slots 58,60 (or, alternatively, recesses) defined in the enlarged diameter portions 96,98. Where a SAW resonator 66 is located in one or more recesses, assembly of the apparatus may be completed by resiliently bending the subject SAW resonator 66 into position.

A yet further alternative embodiment of the present invention is shown in FIG. 12 of the accompanying drawings. In this figure, two SAW resonators 66 extend radially from opposite sides of a yet further shaft 100. This is in contrast to the previously described embodiment wherein the SAW resonators have been arranged so as to extend in a longitudinal direction relative to the associated shaft. In the arrangement of FIG. 12, one end of each SAW resonator 66 is located in a recess 102 provided in the shaft 100. The end of each saw resonator 66 opposite to that located in the recess 102 is itself located in a recess 104 provided in an arm 106. The arrangement shown in FIG. 12 comprises two arms 106, each of which extends spaced from the shaft 100 in a direction parallel to the longitudinal axis of the shaft 100. The arrangement is such that one end 108 of each arm 106 is longitudinally spaced from the associated SAW resonator 66. This end 108 is rigidly secured to the shaft 100. Each arm 106 may be integrally formed with the shaft 100 or attached to said shaft 100 during assembly.

In both the assemblies of FIGS. 11 and 12, it will be understood by a person skilled in the art that the described provision of the SAW resonators 66 will permit the measurement of torque through an associated shaft 94,100.

1. A method of measuring torque transmitted by a member, the method comprising the steps of: connecting a SAW device to said member in such an orientation that, during use of said member, mechanical stress in said member due to a torque transmitted thereby induces bending of the SAW device; and measuring the change in resonant frequency of the SAW device induced by bending thereof to indicate the torque transmitted by the member.

2. A method according to claim 1 wherein: the SAW device comprises a substrate; a first electrode pair is arranged on a first portion of the substrate which is subject to compressive strain during bending of the SAW device; and a second electrode pair is arranged on a second portion of the substrate which is subject to tensile strain during bending of the SAW device.

3. A method according to claim 2, wherein the first and second electrode pairs are located on opposite sides of the substrate.

4. A method according to any preceding claim, wherein the orientation of the SAW device is such that a plane in which the electrodes of the resonator are arranged is perpendicular to the surface of the member adjacent the SAW device.

5. A method according to any preceding claim, wherein the SAW device is arranged such that the longitudinal axis of said member about which torque is applied lies in or is substantially parallel to a plane in which electrodes of the SAW device are arranged.

6. A method according to any preceding claim, wherein the step of connecting a SAW device to said member comprises the step of providing said member with means integral with said member for receiving the SAW device in said orientation.

7. A method according to claim 6, wherein the step of providing means integral with the member comprises providing a slot in the member.

8. A method according to claim 7, wherein the step of providing a slot comprises the step of drilling a hole in said member and forming one or more slots in the wall of the hole.

9. A method according to claim 7, wherein the step of providing a slot comprises the step of forming a recess in said member and forming one or more slots in the walls of the recess.

10. A method according to any of claims 7-9, wherein the slot is of such a size that the SAW device is gripped by the slot.

11. The method of any preceding claim, wherein the step of connecting the SAW device to the member comprises varying the size of a slot in which the member is mounted and/or of the SAW device by varying the temperatures thereof so as to assist in locating the SAW device within the slot.

12. Apparatus for measuring the torque transmitted by a member comprising: a SAW device connected to the member in such an orientation that, during use of the member, mechanical stress in the member due to torque transmitted thereby induces bending of the SAW device; and means for measuring the change in resonant frequency of the SAW device induced by bending thereof to indicate the torque transmitted by the member.

13. Apparatus according to claim 12 wherein: the SAW device comprises a substrate; a first electrode pair is arranged on a first portion of the substrate which is subject to compressive strain during bending of the SAW device; and a second electrode pair is arranged on a second portion of the substrate which is subject to tensile strain during bending of the SAW device.

14. Apparatus according to claim 13, wherein the first and second electrode pairs are located on opposite sides of the substrate.

15. Apparatus according to any of claims 12 to 14, wherein the orientation of the SAW device is such that a plane in which the electrodes of the resonator are arranged is perpendicular to the surface of the member adjacent the SAW device.

16. Apparatus according to any of claims 12 to 15, wherein the SAW device is arranged such that the longitudinal axis of said member about which torque is applied lies in or is substantially parallel to a plane in which electrodes of the SAW device are arranged.

17. Apparatus according to any of claims 12 to 16, wherein the SAW device is connected to the member by means integral with said member which receive the SAW device in said orientation.

18. Apparatus according to claim 17, wherein the means integral with the member comprises a slot in the member.

19. Apparatus according to claim 17, wherein the member has a hole drilled therein and the or each slot is in the wall of the hole.

20. Apparatus according to claim 17, wherein the member has a recess formed therein and the or each slot is in the walls of the recess.
